(19) United States
(12) Patent Application Publication
(10) Pub. No.: US 2020/0366344 A1
(43) Pub. Date: Nov. 19, 2020

(54) METHOD AND APPARATUS FOR PRECODER DETERMINATION AND PRECODER MATRIX INDICATOR (PMI) INDICATION FOR UPLINK TRANSMISSION

(71) Applicant: Apple Inc., Cupertino, CA (US)

(72) Inventors: Alexei Davydov, Nizhny Novgorod NIZ (RU); Yushu Zhang, Beijing (CN); Victor Sergeev, Nizhny Novgorod NIZ (RU); Guotong Wang, Beijing (CN); Leiqin Yan, Beijing (CN)

(21) Appl. No.: 16/637,151

(22) PCT Filed: Aug. 6, 2018
(86) PCT No.: PCT/CN2018/098959

§ 371 Date: Feb. 6, 2020

(30) Foreign Application Priority Data
Aug. 9, 2017 (CN) PCT/CN2017/096660
Jan. 8, 2018 (CN) PCT/CN2018/071778

(51) Int. Cl. H04B 7/0456; H04B 7/06; H04W 80/08; H04W 72/04

(52) U.S. Cl. CPC H04B 7/0456; H04W 72/042; H04W 80/08; H04B 7/0639

(57) ABSTRACT

Provided herein are method and apparatus for precoder determination and precoder matrix indicator (PMI) indication for uplink transmission. The disclosure provides an apparatus for a user equipment (UE), comprising circuitry configured to: determine a precoder for each of a plurality of precoder resource block groups (PRGs) for an uplink transmission, wherein the plurality of PRGs are configurable in at least one of PRG size and number; and precode each of the plurality of PRGs with a determined precoder; and a memory to store the determined precoder for each of the plurality of PRGs.

### CROSS REFERENCES TO RELATED APPLICATIONS

This application claims priority to International Application No. PCT/CN2017/096660 filed on Aug. 9, 2017, entitled “CONTROL SIGNALING OF UPLINK OPEN-LOOP TRANSMISSION” and International Application No. PCT/CN2018/071778 filed on Jan. 8, 2018, entitled “UPLINK (UL) SUB-BAND TRANSMIT PRECODER MATRIX INDICATOR (TPMI) INDICATION”, both of which are incorporated by reference herein in their entirety for all purposes.

### TECHNICAL FIELD

Embodiments of the present disclosure generally relate to wireless communication, and in particular to method and apparatus for precoder determination and precoder matrix indicator (PMI) indication for uplink transmission.

### BACKGROUND ART

In fifth generation (5G) communication technology, both of Discrete Fourier Transform-Spread Orthogonal Frequency Division Multiplexing (DFT-S-OFDM) and Cyclic Prefix (CP) OFDM waveform may be used for an uplink transmission. In particular, the CP OFDM waveform may be used when a User Equipment (UE) is working in a good coverage case, rather than in coverage limited case. Precoding related technology for CP OFDM waveform for the uplink transmission will be described in the present disclosure.

### SUMMARY

An embodiment of the disclosure provides an apparatus for a user equipment (UE), the apparatus including: circuitry configured to: determine a precoder for each of a plurality of precoder resource block groups (PRGs) for an uplink transmission, wherein the plurality of PRGs are configurable in at least one of PRG size and number; and precode each of the plurality of PRGs with a determined precoder; and a memory to store the determined precoder for each of the plurality of PRGs.

An embodiment of the disclosure provides a method performed at a user equipment (UE), including: determining a precoder for each of a plurality of precoder resource block groups (PRGs) for an uplink transmission, wherein the plurality of PRGs are configurable in at least one of PRG size and number; and precoding each of the plurality of PRGs with a determined precoder.

An embodiment of the disclosure provides an apparatus for a user equipment (UE), including: circuitry configured to: determine a plurality of precoder matrix indicators (PMIs) for a plurality of precoder resource block groups (PRGs) for an uplink transmission based on higher layer signaling or downlink control information (DCI) transmitted from an access node, wherein the plurality of PRGs are configurable in at least one of PRG size and number; and a memory to store the determined plurality of PMIs.

An embodiment of the disclosure provides a method performed at a user equipment (UE), including: determining a plurality of precoder matrix indicators (PMIs) for a plurality of precoder resource block groups (PRGs) for an uplink transmission based on higher layer signaling or downlink control information (DCI) transmitted from an access node, wherein the plurality of PRGs are configurable in at least one of PRG size and number.

### BRIEF DESCRIPTION OF THE DRAWINGS

Embodiments of the disclosure will be illustrated, by way of example and not limitation, in the figures of the accompanying drawings in which like reference numerals refer to similar elements.

FIG. 1 shows an example of a communication system in accordance with some embodiments of the disclosure.

FIG. 2 is a flow chart showing a method for precoder determination in accordance with some embodiments of the disclosure.

FIG. 3 is a flow chart showing a method for precoder determination in accordance with some embodiments of the disclosure.

FIG. 4 shows an example of association between PMIs and PRGs in accordance with some embodiments of the disclosure.

FIG. 5 shows an example of PRGs each of which includes only one or more scheduled PRBs in accordance with some embodiments of the disclosure.

FIG. 6 shows an example of PRGs of which at least one PRG includes both of one or more scheduled PRBs and one or more unscheduled PRBs in accordance with some embodiments of the disclosure.

FIG. 7a shows a PMI indication scheme in accordance with some embodiments of the disclosure.

FIG. 7b shows a PMI indication scheme in accordance with some embodiments of the disclosure.

FIG. 8 illustrates example components of a device in accordance with some embodiments of the disclosure.

FIG. 9 illustrates example interfaces of baseband circuitry in accordance with some embodiments.

FIG. 10 is a block diagram illustrating components, according to some example embodiments, able to read instructions from a machine-readable or computer-readable medium and perform any one or more of the methodologies discussed herein.

### DETAILED DESCRIPTION OF EMBODIMENTS

Various aspects of the illustrative embodiments will be described using terms commonly employed by those skilled in the art to convey the substance of their work to others skilled in the art. However, it will be apparent to those skilled in the art that many alternate embodiments may be practiced using portions of the described aspects. For purposes of explanation, specific numbers, materials, and configurations are set forth in order to provide a thorough understanding of the illustrative embodiments. However, it will be apparent to those skilled in the art that alternate embodiments may be practiced without the specific details. In other instances, well known features may have been omitted or simplified in order to avoid obscuring the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in an embodiment” is used repeatedly herein. The phrase generally does not refer to the same embodiment; however, it may. The terms “comprising,” “having,” and “including” are synonymous, unless the context dictates otherwise. The phrases “A or B” and “A/B” mean “(A), (B), or (A and B).”

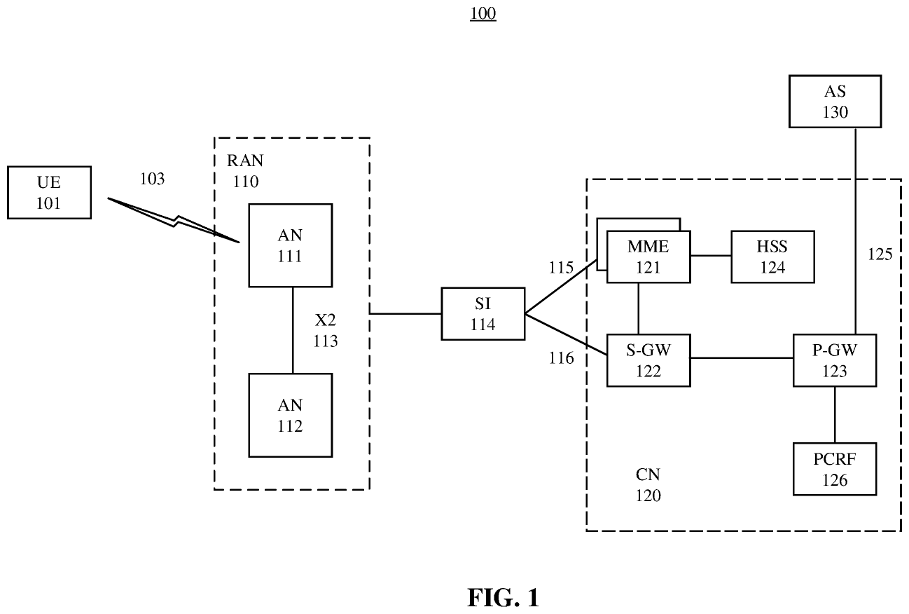

FIG. 1 shows an example of a communication system 100 in accordance with some embodiments of the disclosure. The communication system 100 is shown to include a user equipment (UE) 101. The UE 101 is illustrated as a smartphone (e.g., a handheld touchscreen mobile computing device connectable to one or more cellular networks). However, it may also include any mobile or non-mobile computing device, such as a personal data assistant (PDA), a tablet, a pager, a laptop computer, a desktop computer, a wireless handset, or any computing device including a wireless communications interface.

The UE 101 may be configured to connect, e.g., communicatively couple, with a radio access network (RAN) 110, which may be, for example, an Evolved Universal Mobile Telecommunications System (UMTS) Terrestrial Radio Access Network (E-UTRAN), a NextGen RAN (NG RAN), or some other type of RAN. The UE 101 may operate in consistent with cellular communications protocols, such as a Global System for Mobile Communications (GSM) protocol, a Code-Division Multiple Access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

The RAN 110 may include one or more access nodes (ANs). These ANs may be referred to as base stations (BSs), NodeBs, evolved NodeBs (eNBs), next Generation NodeBs (gNBs), and so forth, and may include ground stations (e.g., terrestrial access points) or satellite stations providing coverage within a geographic area (e.g., a cell). As shown in FIG. 1, for example, the RAN 110 includes AN 111 and AN 112. The UE 101 may enable communicative coupling with the RAN 110 by utilizing connection 103 with AN 111, as shown in FIG. 1. The AN 111 and AN 112 may communicate with one another via an X2 interface 113. The AN 111 and AN 112 may be macro ANs which may provide lager coverage. Alternatively, they may be femtocell ANs or picocell ANs, which may provide smaller coverage areas, smaller user capacity, or higher bandwidth compared to a macro AN. For example, one or both of the AN 111 and AN 112 may be a low power (LP) AN. In an embodiment, the AN 111 and AN 112 may be the same type of AN. In another embodiment, they are different types of ANs.

The AN 111 may terminate the air interface protocol and may be the first point of contact for the UE 101. In some embodiments, the ANs 111 and 112 may fulfill various logical functions for the RAN 110 including, but not limited to, radio network controller (RNC) functions such as radio bearer management, uplink and downlink dynamic radio resource management and data packet scheduling, and mobility management.

In accordance with some embodiments, the UE 101 may be configured to communicate using Orthogonal Frequency-Division Multiplexing (OFDM) communication signals with the AN 111 or with other UEs over a multicarrier communication channel in accordance with various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and Proximity-Based Service (ProSe) or sidelink communications), although the scope of the embodiments is not limited in this respect. The OFDM signals can include a plurality of orthogonal subcarriers.

In some embodiments, a downlink resource grid may be used for downlink transmissions from the AN 111 to the UE 101, while uplink transmissions may utilize similar techniques. The grid may be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated.

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced control channel elements (ECCEs). Similar to above, each ECCE may correspond to nine sets of four physical resource elements known as an enhanced resource element groups (EREGs). An ECCE may have other numbers of EREGs in some situations.

The RAN 110 is shown to be communicatively coupled to a core network (CN) 120 via an S1 interface 114. In some embodiments, the CN 120 may be an evolved packet core (EPC) network, a NextGen Packet Core (NPC) network, or some other type of CN. In an embodiment, the S1 interface 114 is split into two parts: the S1-mobility management entity (MME) interface 115, which is a signaling interface between the ANs 111 and 112 and MMEs 121; and the S1-U interface 116, which carries traffic data between the ANs 111 and 112 and a serving gateway (S-GW) 122.

In an embodiment, the CN 120 may comprise the MMEs 121, the S-GW 122, a Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-AN handovers and also may provide an anchor for inter-3GPP mobility. Other responsibilities may include lawful intercept, charging, and some policy enforcement.

The P-GW 123 may terminate a SGi interface toward a PDN. The P-GW 123 may route data packets between the CN 120 and external networks such as a network including an application server (AS) 130 (alternatively referred to as application function (AF)) via an Internet Protocol (IP) interface 125. Generally, the application server 130 may be an element offering applications that use IP bearer resources with the core network (e.g., UMTS Packet Services (PS) domain, LTE PS data services, etc.). In an embodiment, the P-GW 123 is communicatively coupled to an application server 130 via an IP communications interface. The application server 130 may also be configured to support one or more communication services (e.g., Voice-over-Internet Protocol (VoIP) sessions, PTT sessions, group communication sessions, social networking services, etc.) for the UE 101 via the CN 120.

The P-GW 123 may further be responsible for policy enforcement and charging data collection. Policy and Charging Rules Function (PCRF) 126 is a policy and charging control element of the CN 120. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 126 may be communicatively coupled to the application server 130 via the P-GW 123. The application server 130 may signal the PCRF 126 to indicate a new service flow and select the appropriate Quality of Service (QoS) and charging parameters. The PCRF 126 may provision this rule into a Policy and Charging Enforcement Function (PCEF) (not shown) with an appropriate traffic flow template (TFT) and QoS class of identifier (QCI), which commences the QoS and charging as specified by the application server 130.

The quantity of devices and/or networks illustrated in FIG. 1 is provided for explanatory purposes only. In practice, there may be additional devices and/or networks, fewer devices and/or networks, different devices and/or networks, or differently arranged devices and/or networks than illustrated in FIG. 1. Alternatively or additionally, one or more of the devices of system 100 may perform one or more functions described as being performed by another one or more of the devices of system 100. Furthermore, while “direct” connections are shown in FIG. 1, these connections should be interpreted as logical communication pathways, and in practice, one or more intervening devices (e.g., routers, gateways, modems, switches, hubs, etc.) may be present.

An uplink transmission refers to a transmission from a UE (e.g., UE 101) to an AN (e.g., AN 111). The present disclosure is mainly related to uplink multiple input and multiple output (MIMO) transmission, hereinafter also called uplink transmission for simplicity. In the present disclosure, the uplink transmission may include transmission of physical uplink share channel (PUSCH), physical uplink control channel (PUCCH) and other reference signal (e.g., sounding reference signal (SRS)). In the uplink transmission, CP OFDM waveform technology may be used. For a system using CP OFDM waveform technology, an open-loop transmission scheme and/or a close-loop transmission scheme may be used. There are a number of schemes to implement an open-loop transmission, e.g., precoder cycling. Also, There are a number of schemes to implement a close-loop transmission, e.g., frequency selective precoding.

Generally, both of precoder cycling and frequency selective precoding are related to selecting different precoders for different Precoder Resource block Groups (PRGs) or sub-bands. Herein, each PRG or sub-band may include one or more Physical Resource Blocks (PRBs). Precoder cycling, however, is directed to selecting a precoder for a respective PRG or sub-band in open-loop fashion, while frequency selective precoding is directed to selecting a precoder for a respective PRG or sub-band in a close-loop fashion.

For precoder cycling, the UE 101 may determine a precoder for each of a plurality of PRGs for the uplink transmission and then precode each of the plurality of PRGs with a determined precoder. In other words, the UE 101 may try different precoders for different PRGs so that some precoders may happen to be at or around the best transmission direction for the uplink transmission. In some embodiments, the determined precoder for each of the plurality of PRGs may be stored in a memory at the UE 101.

Generally, there are two ways for precoder determination by the UE 101. In some embodiments, the UE 101 may perform the precoder determination independently without any assistance from the AN 111. In some embodiments, the UE 101 may perform the precoder determination with assistance from the AN 111.

In some embodiments, whether assistance from the AN 111 is required in the precoder determination may be based on one of predefinition, higher layer signaling or downlink control information (DCI) from the AN 111, and the number of transmission antenna ports of the UE 101. In specifically, in an embodiment where whether assistance from the AN 111 is required in the precoder determination is determined by the number of transmission antenna ports of the UE 101, if the number of the transmission antenna ports is smaller than or equal to 2, the UE 101 may perform the precoder determination independently; otherwise, the UE 101 may perform the precoder determination with assistance from the AN 111.

In the embodiments where the UE 101 performs the precoder determination independently, the UE 101 may, for example, randomly, select the precoder for each of the plurality of PRGs from a codebook. The codebook may be predefined. In these embodiments, interference to the system is significant as the UE 101 performs the precoder determination without assistance from the AN 111.

Embodiments where the UE 101 performs the precoder determination with assistance from the AN 111 are described in details below.

In some embodiment, the AN 111 may transmit a codebook subset restriction to the UE 101, for example, via higher layer signaling (e.g. radio resource control (RRC) signaling) or DCI. The codebook subset restriction may indicate a subset of a codebook. The codebook subset restriction may include a bitmap, for example, including bits “1” and/or “0”. Each bit of the bitmap may correspond to a precoder within the codebook, that is, the size of the bitmap may equal to the number of precoders within the codebook. For example, bit “1” may indicate that corresponding precoder is valid, and bit “0” may indicate that corresponding precoder is invalid, and vice versa. With the codebook subset restriction, the UE 101 may select a precoder for each of the plurality of PRGs from a subset of the codebook rather than the complete codebook.

In some embodiments, the UE 101 may obtain one or more precoder matrix indicators (PMIs), which may also be referred as to transmission precoder matrix indicators (TPMIs) in some embodiments, and then determine the precoder for each of the plurality of PRGs based on the one or more PMIS. The UE 101 may obtain the one or more PMI by decoding higher layer signaling or (DCI) transmitted from the AN 111. The higher layer signaling or DCI may be either newly configured higher layer signaling or DCI or existing higher layer signaling or DCI. For example, in an embodiment, the higher layer signaling or DCI is dedicated to indicate the one or more PMIS. In another embodiment, the higher layer signaling or DCI is associated with uplink grant for the uplink transmission.

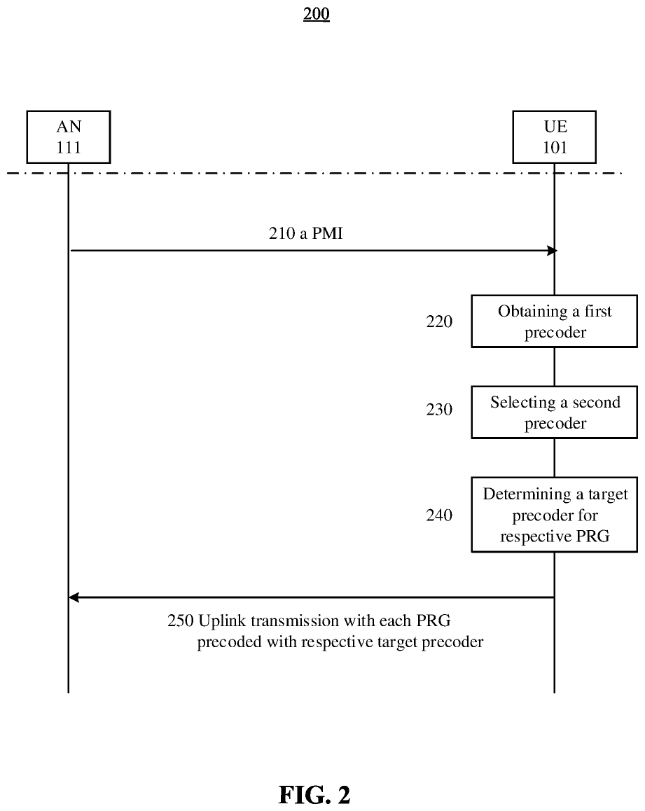

FIG. 2 is a flow chart showing a method 200 for precoder determination in accordance with some embodiments of the disclosure.

At 210, the AN 111 may transmit a single PMI to the UE 101 via higher layer signaling or DCI. The single PMI may be used to indicate a first precoder for all of the plurality of the PRGs. The PMI is just an indicator rather than the first precoder itself, therefore the UE 101 may, at 220, obtain the first precoder based on the PMI and a first codebook. The first codebook may be predefined. The UE 101 may determine the first precoder from the first codebook based on the PMI. The first precoder is not a target precoder that may be used to perform precoding for the uplink transmission by the UE 101. Instead, the first precoder may be used to determine a coarse transmission direction for the uplink transmission.

At 230, the UE 101 may select, for each of the plurality of PRGs, a second precoder from a second codebook. The second codebook may be predefined. In an embodiment, the second codebook is different from the first codebook. In an embodiment, the second codebook is the same as the first codebook. As the coarse transmission direction for the uplink transmission has been determined by the first precoder, the UE 101 may select the second precoder from the second codebook. In an embodiment, the UE 101 may select the second precoder in a random way. In another embodiment, the UE 101 may select the second precoder based on a particular rule rather than randomly. In other words, the UE 101 may select a same precoder for at least two of the plurality of PRGs; also, the UE 101 may select totally different precoders for different PRGs. The second precoder for each PRG may be used to indicate a finer transmission direction.

At 240, the UE 101 may determine a target precoder for a respective PRG based on the first precoder and a respective second precoder. Mathematically, the first precoder may be represented by a matrix W₁, and the second precoder for PRG j may be represented by a matrix W_{2,j}. In an embodiment, the target precoder for PRG j, which is represented by a matrix W^{(j)}, may be determined as product of W₁ and W_{2,j}, as shown in Equation (1) below.

W^{(j)}=W₁W_{2,j} (1)

At 250, the UE 101 may perform uplink transmission with each of the plurality of PRGs precoded by a respective target precoder.

In an optional embodiment, the AN 111 may transmit a codebook subset restriction to the UE 101, for example, via higher layer signaling (e.g. RRC signaling) or DCI. For example, in an embodiment, the UE 101 may obtain a first codebook subset restriction indicating a subset of the first codebook, then the UE 101 may determine the first precoder based on the subset of the first codebook and the PMI obtained at 210. In this way, overhead for PMI may be decreased, as the size of the codebook, on which the first precoder is determined based, is decreased to the size of a subset of the first codebook. In an embodiment, each bit in the bitmap for the first codebook subset restriction is associated with one Discrete Fourier Transform (DFT) beam. If a DFT beam is restricted by a bit, the UE 101 may assume that all PMIS that contain this DFT beam should be restricted.

In an embodiment, the UE 101 may obtain a second codebook subset restriction indicating a subset of the second codebook, then the UE 101 may select the second precoder from the subset of the second codebook. In this way, the scope for the selection of the second precoder by the UE 101 may be decreased so that complexity of selection may be decreased.

In some embodiments, the UE 101 may obtain a single codebook subset restriction comprising a plurality of bitmaps each of which corresponds to a respective codebook. For example, the UE 101 may obtain a codebook subset restriction comprising two bitmaps that respectively correspond to the first codebook and the second codebook.

In the embodiments of FIG. 2, the UE 101 may determine the precoder for each of the plurality of PRGs based on both of the first precoder, which is related to the coarse transmission direction, and the second precoder for each PRG, which is related to the finer transmission direction.

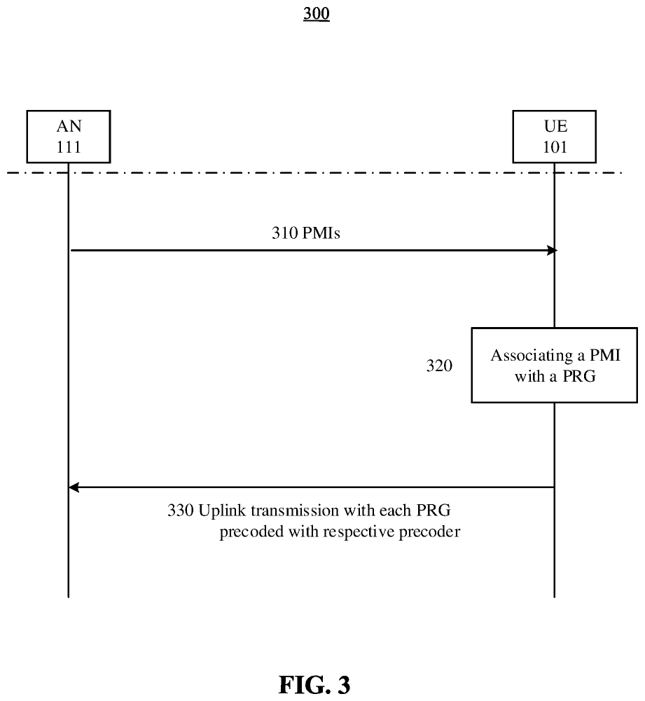

There are some other methods to determine the precoders with assistance from the AN 111. FIG. 3 is a flow chart showing a method 300 for precoder determination in accordance with some embodiments of the disclosure.

Compared with the embodiments in FIG. 2, the AN 111 may, at 310, transmit a plurality of PMIS to the UE 101, e.g., via higher layer signaling or DCI, rather than a single PMI in FIG. 2. Among the plurality of PMIS, in an embodiment, at least two different PMIS may have the same value, that is, the at least two PMIS may correspond to the same precoder. In another embodiment, the plurality of PMIS are different with one another, that is, the plurality of PMIS may correspond to different precoders that are different with one another. At 320, the UE 101 may associate one of the plurality of PMIS with one of the plurality of PRGs to determine the precoder for each of the plurality of PRGs. Specifically, each PMI may correspond to a precoder within a codebook, so that the UE 101 may determine the precoder for each PRG based on the corresponding PMI and the codebook. At 330, the UE 101 may perform uplink transmission with each of the plurality of PRGs precoded by a respective precoder.

For step 320, there are different ways to associate the PMIS with the PRGs. In some embodiments, the UE 101 may configure PRGs based on the number of the PMIS indicated by the AN 111. In particular, the UE 101 may configure the number of PRGs to be the same as that of the PMIS. As a result, the UE 101 may associate each of the PMIS with one of the PRGs sequentially as the number of PRGs is equal to that of the PMIS.

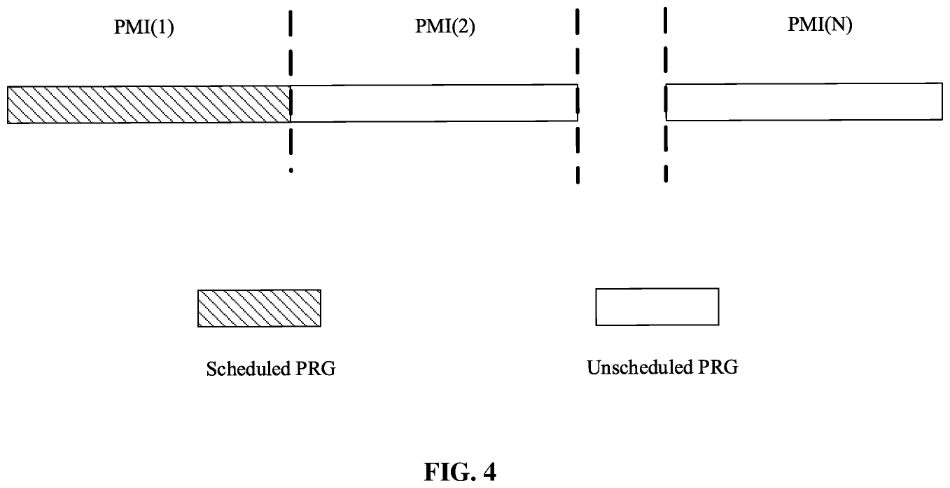

FIG. 4 shows an example of association between PMIS and PRGs in accordance with some embodiments of the disclosure. In the embodiments, the UE 101 configures the number of PRGs to be the same as that of the PMIS. For example, the total number of both of the PRGs and the PMIS is N as shown in FIG. 4. The plurality of PRGs may include one or more unscheduled PRGs, for example, PRG 2 and PRG N as shown in FIG. 4. In the embodiments, each of the one or more unscheduled PRGs may be associated with a PMI that has a predefined value. For example, PRG 2 and PRG N are associated with PMI(2) and PMI(N) respectively. Value of PMI(2) and value of PMI(N) are the same and both are equal to a predefined value which is used to indicate that the corresponding PRG is unscheduled.

The UE 101 may know whether a PRG is unscheduled through not only the value of corresponding PMI, but also resource allocation information. In this way, the UE 101 may detect whether the higher layer signaling or DCI is decoded correctly. For example, if only one of the value of corresponding PMI and the resource allocation information indicates a PRG is unscheduled, but the other one indicate the PRG is scheduled, the higher layer signaling or DCI may be determined to be decoded incorrectly.

The embodiments where the number of PRGs is configured to be the same as that of the PMIS are described in conjunction with FIG. 4. In some embodiments, there is no relationship between the number of PRGs and the number of the PMIS.

In an embodiment, the number of the plurality of PMIS is not equal to the number of the plurality of PRGs. The UE 101 may select a PMI from the plurality of PMIS received from the AN 111 and associate the PMI with one of the plurality of PRGs, e.g., in a random way. In an embodiment, a same PMI may be selected to associate with different PRGs. However, one PRG may only be associated with one PMI.

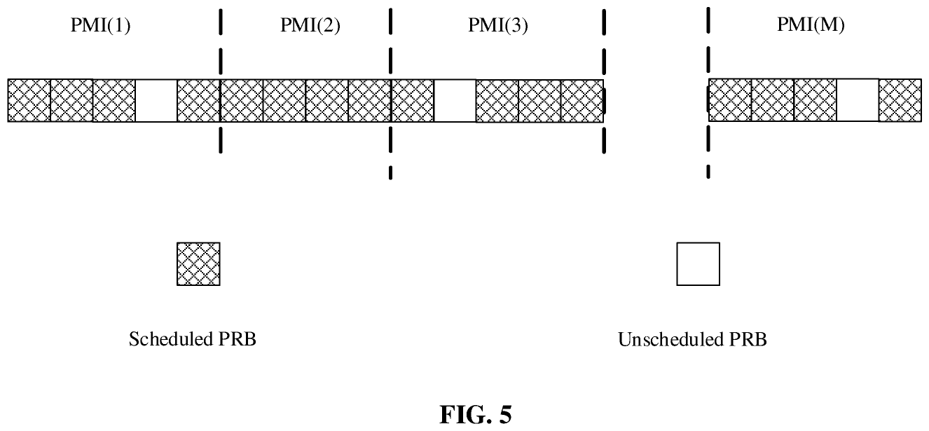

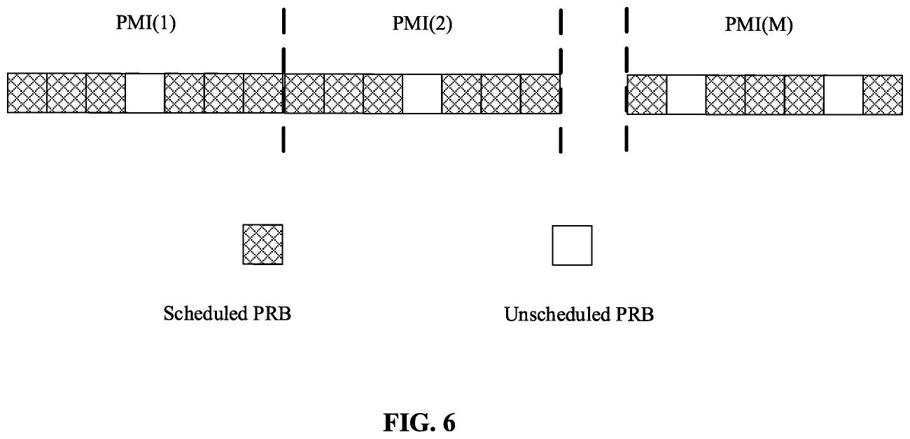

As mentioned above, each PRG may include one or more PRBs. In an embodiment, each PRG of the plurality of PRGs may include one or more scheduled PRBs but no unscheduled PRBs. In another embodiments, at least one of the plurality of PRGs may include both of one or more scheduled PRBs and one or more unscheduled PRBs. FIG. 5 shows an example of PRGs each of which includes only one or more scheduled PRBs in accordance with some embodiments of the disclosure. FIG. 6 shows an example of PRGs of which at least one PRG includes both of one or more scheduled PRBs and one or more unscheduled PRBs in accordance with some embodiments of the disclosure.

As shown in FIG. 5, there are M PRGs. Each PRG may correspond to a PMI, e.g., PMI(1), PMI(2), PMI(3), . . . PMI(M), and in turn, each PMI may correspond to a precoder, e.g., W⁽¹⁾, W⁽²⁾, W⁽³⁾, . . . W^{(M)} (not shown). In the embodiments, each PRG may include the same number of PRBs and the PRBs included in each PRG are scheduled. As shown in FIG. 5, PRG 1 that corresponds to PMI(1) includes four scheduled PRBs, which are non-contiguous in physical resource; PRG 2 that corresponds to PMI(2) includes four scheduled PRBs, which are contiguous in physical resource; PRG 3 that corresponds to PMI(3) includes four scheduled PRBs, which are non-contiguous in physical resource; and PRG M that corresponds to PMI(M) includes four scheduled PRBs, which are non-contiguous in physical resource.

However, in some embodiments, at least one of the plurality of PRGs may include both of one or more scheduled PRBs and one or more unscheduled PRBs. As shown in FIG. 6, there are M PRGs. Each PRG may correspond to a PMI, e.g., PMI(1), PMI(2), . . . PMI(M), and in turn, each PMI may correspond to a precoder, e.g., W⁽¹⁾, W⁽²⁾, . . . W^{(M)} (not shown). In the embodiments, each PRG may include the same number of PRBs and the PRBs included in each PRG are scheduled or unscheduled. As shown in FIG. 6, PRG 1 corresponding to PMI(1) includes seven contiguous PRBs including six scheduled PRBs and one unscheduled PRB; PRG 2 corresponding to PMI(2) includes seven contiguous PRBs including six scheduled PRBs and one unscheduled PRB; and PRG M corresponding to PMI(M) includes seven contiguous PRBs including five scheduled PRBs and two unscheduled PRB.

In the embodiments in FIG. 5, PRG allocation is based on channel physical characteristics. However, in the embodiments in FIG. 6, PRG allocation is based on physical resource allocation.

Both of FIG. 5 and FIG. 6 illustrate each PRG includes the same number of PRBs, irrespective of only scheduled ones or both of scheduled ones and unscheduled ones are included. However, in some embodiments, the number of PRBs included in different PRGs may be different. The present disclosure is not limited in this respect.

In some embodiments, the plurality of PRGs may include one or more different PRBs in frequency domain that occupy the same time resource. In some embodiments, the plurality of PRGs may include one or more different time units in time domain that occupy the same frequency resource. Herein, one time unit may include a slot or a symbol, which is predefined or configured by higher layer signaling or DCI. Each PRG may include a plurality of symbols or one or more slots.

In other words, in some embodiments, the plurality of PRGs may occupy the same resource in time domain, but each PRG may occupy different resource in frequency domain. Such PRGs may be called as frequency domain PRGs herein. Alternatively, in some embodiments, the plurality of PRGs may occupy the same resource in frequency domain, but each PRG may occupy different resource in time domain. Such PRGs may be called as time domain PRGs herein. For example, the PRGs in FIG. 4, FIG. 5 or FIG. 6 may be frequency domain PRGs or time domain PRGs. The embodiments are not limited in this respect.

In some embodiments, PRG size and/or number of the PRGs may be configurable. Herein, the PRG size refers to the number of PRBs and/or time units included in each PRG. Since different precoders can be used for different PRGs, if the number of PRGs is small, more transmission directions will be covered. But some channel estimation performance loss may be observed especially when time domain channel estimation is used. Hence a proper PRG size would result in better performance.

There are several ways to determine the PRG size and/or the number of PRGs. In an embodiment, the PRG size and/or the number of PRGs may be predefined. In an embodiment, the PRG size and/or the number of PRGs may be indicated by higher layer signaling or DCI. In above two ways, the PRG size of different PRGs may be the same as or different from one another. The embodiments are not limited in this respect. Furthermore, both of frequency domain PRGs and time domain PRGs may be configurable in the PRG size and/or number through the above two ways. The embodiments are not limited in this respect.

In an embodiment, the PRG size and/or the number of PRGs may be determined based on bandwidth associated with the plurality of PRGs. In this embodiment, the plurality of PRGs may include one or more different PRBs in frequency domain that occupy the same time resource. The bandwidth associated with the plurality of PRGs may include one of system bandwidth, bandwidth of corresponding bandwidth part (BWP) where the plurality of PRGs are located, and bandwidth allocated for the uplink transmission. Specifically, when the total number of PRBs allocated for uplink transmission is N and the number of PRGs is P, the PRG size of each PRG may be

$$⌊ \frac{{N}_{RB}}{P} ⌋ or ⌈ \frac{{N}_{RB}}{P} ⌉ .$$

Alternatively, when the total number of PRBs allocated for uplink transmission is N and the PRG size of each PRG is S, the number of PRGs may be

$$⌊ \frac{{N}_{RB}}{S} ⌋ or ⌈ \frac{{N}_{RB}}{S} ⌉ .$$

In an embodiment, the PRG size and/or the number of PRGs may be determined based on demodulation reference signal (DMRS) information. In this embodiment, the plurality of PRGs may include one or more different time units in time domain that occupy the same frequency resource. Each PRG may need a DMRS for demodulation, thus a DMRS may be configured for each PRG. For example, one time unit includes a symbol and a DMRS comes after every three PUSCH symbols, then each PRG may include 4 symbols, that is, four time units may be included in each PRG. In other word, in this example, the PRG size may be four time units. Then the number of PRGs may be determined based on total time units and the PRG size. As the PRG size is determined based on the DMRS information, the number of PRGs may be determined based on DMRS information indirectly.

In an embodiment, the PRG size and/or the number of PRGs may be determined based on both of bandwidth associated with the plurality of PRGs and the DMRS information. The bandwidth may not be wide enough to cover all the precoders, in this case, the UE 101 may first determine some frequency domain PRGs. Then the remaining one or more precoders may correspond to one or more time domain PRGs which share the same frequency resource as the frequency domain PRGs. As mentioned above, each time domain PRG may have a DMRS. Thus, in the embodiment, the PRG size and/or the number of PRGs may be determined both of bandwidth associated with the plurality of PRGs and the DMRS information

The association between the PMIS and the PRGs, PRG allocation, and the determination of the PRG size and/or the number of PRGs above are not limited to precoding cycling, also, they may be applicable to frequency selective precoding. Below, PMI indication will be described in details. Also, the PMI indication schemes herein may be applicable to both of precoding cycling and frequency selective precoding.

In 3GPP TS 38.212 V2.0.0 (2017-12), there are three levels of UE capability for uplink MIMO transmission: full coherence, partial coherence, and non-coherence. The full coherence refers all ports can be transmitted coherently. The partial coherence refers port pairs can be transmitted coherently. The non-coherence refers no port pairs can be transmitted coherently.

Since MIMO transmission capability for UE is different in each of the above mentioned levels, for each case, only a subset of the codebook is required. As such, the number of PMIS may be adjusted to match the multiplicity of the subset, and avoid using extra overhead for PMI indication.

Table 1 below shows an example of the number of PMIS for the codebook for DFT-s-OFDM transmission. In the example, there are four antenna ports, max rank for precoder may be 2, 3, or 4.

| Full coherent | Partial coherent | Non-coherence |
|---|---|---|
| 1 layer, PMI_{0-27,} | 1 layer, PMI_{0-11,} | 1 layer, PMI_{0-3,} |
| 5 bits | 4 bits | 2 bits |
| 2 layers, PMI_{0-21,} | 2 layers, PMI_{0-13,} | 2 layers, PMI_{0-5,} |
| 5 bits | 4 bits | 3 bits |
| 3 layers, PMI_{0-6,} | 3 layers, PMI_{0-2,} | 3 layers, PMI_{0,} |
| 3 bits | 2 bits | 1 bit |
| 4 layers, PMI_{0-4,} | 4 layers, PMI_{0-2,} | 4 layers, PMI_{0,} |
| 3 bits | 2 bits | 1 bit |

As can be seen from the Table 1, for full coherent, for example, if there is 1 layer, the number of PMIS may be 28, thus, 5 bits are needed to indicate each of the 28 PMIS.

The above Table 1 and related content in 3GPP TS 38.212 V2.0.0 is related to DFT-s-OFDM transmission. In the present disclosure, there are a number of PMI indication methods for CP-OFDM transmission including, for example, both of precoding cycling and frequency selective precoding.

In some embodiments, the AN 111 may transmit a plurality of PMIS for a plurality of PRGs for an uplink transmission to the UE 101 via higher layer signaling or DCI. There are a number of schemes to indicate the PMIS.

In some embodiment, the higher layer signaling or DCI may include a plurality of bit strings each of which indicates one of the plurality of PMIS. In an embodiment, bit-width of each bit string is configured based on maximum number of PMIS among all the ranks. For example, if rank for precoder is 1, i.e., there is one layer, the number of bits for the PMI is maximal. Then the bit-width of each bit string is configured based on the number of PMIS for rank 1. In these embodiments, one bit string only indicates one PMI, so that the overhead may be increased when there are a lot of PMIS to be indicated.

In some embodiments, in order to decrease the overhead for PMI indication, the higher layer signaling or DCI may include a set of offset values and a baseline PMI. The plurality of PMIS may be determined based on the baseline PMI and the set of offset values. Each offset value within the set of offset values may correspond to a PMI. In an embodiment, the offset values may be any integers, such as 1, 2, −1, −1, 0 and the like. In some embodiments, the baseline PMI may be indicated by a bit string as mentioned above.

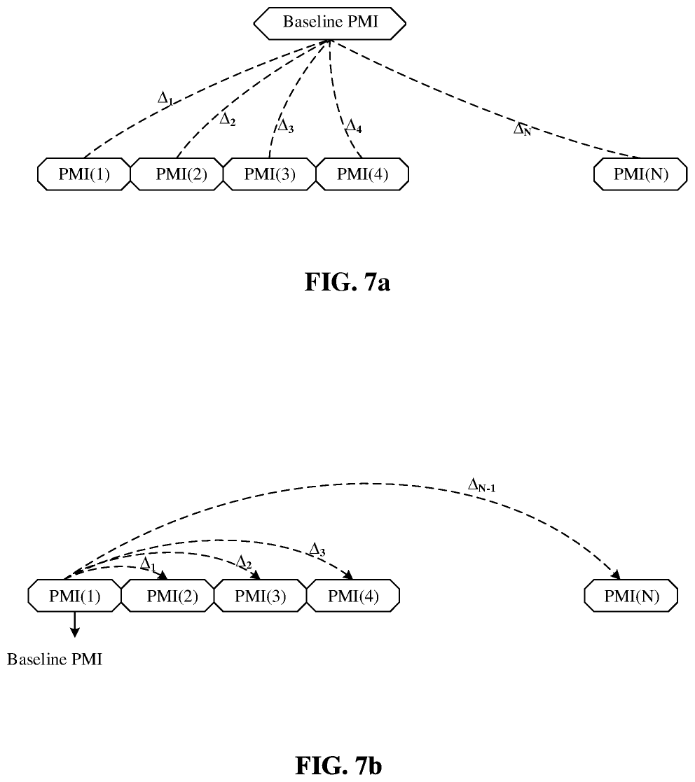

FIG. 7a shows a PMI indication scheme in accordance with some embodiments of the disclosure. In the embodiment, the baseline PMI is configured to indicate a PMI corresponding to a frequency band associated with the uplink transmission. The frequency band associated with the uplink transmission may include, for example, the BWP where the PRGs for the uplink transmission are located or the frequency band allocated for the uplink transmission.

FIG. 7b shows a PMI indication scheme in accordance with some embodiments of the disclosure. Compared with the embodiment of FIG. 7a, in the embodiment of FIG. 7b, the baseline PMI is configured to indicate a PMI for a particular PRG of the plurality of PRGs.

In some embodiments, for FIG. 7a or FIG. 7b, each offset value within the set of offset values may indicate an offset value for a PMI associated with a corresponding PRG with respect to the baseline PMI. In an embodiment of FIG. 7a, PMI(1) associated with, for example, PRG 1 may be calculated based on the baseline PMI and corresponding offset value Δ₁; PMI(2) may be calculated based on the baseline PMI and corresponding offset value Δ₂; PMI(3) may be calculated based on the baseline PMI and corresponding offset value Δ₃; PMI(4) may be calculated based on the baseline PMI and corresponding offset value Δ₄; and PMI(N) may be calculated based on the baseline PMI and corresponding offset value Δ_{N}. In an embodiment of FIG. 7b, the baseline PMI indicates PMI(1), and other PMIS may be determined based on PMI(1) and corresponding offset values. For example, PMI(2) may be calculated based on PMI(1) and corresponding offset value Δ₁; PMI(3) may be calculated based on PMI(1) and corresponding offset value Δ₂; PMI(4) may be calculated based on PMI(1) and corresponding offset value Δ₃; and PMI(N) may be calculated based on PMI(1) and corresponding offset value Δ_{N-1}. In the embodiment of FIG. 7b, the baseline PMI is illustrated to indicate PMI(1). The baseline PMI may indicate any PMI, which is not limited in the embodiments of the present disclosure.

In some embodiments, for FIG. 7a or FIG. 7b, at least one offset value within the set of offset values may indicate an offset value for a PMI associated with a corresponding PRG of the plurality of PRGs with respect to a PMI associated with an adjacent PRG of the PRG. For example, in the embodiments where the baseline PMI is configured to indicate a PMI corresponding to a frequency band associated with the uplink transmission, for example, in an embodiment of FIG. 7a, PMI(1) may be calculated based on the baseline PMI and corresponding offset value Δ₁; PMI(2) may be calculated based on PMI(1) and corresponding offset value Δ₂; PMI(3) may be calculated based on PMI(2) and corresponding offset value Δ₃; PMI(4) may be calculated based on PMI(3) and corresponding offset value Δ₄; and PMI(N) may be calculated based on the PMI(N−1) and corresponding offset value Δ_{N}. In the embodiments where the baseline PMI is configured to indicate a PMI for a particular PRG of the plurality of PRGs, for example, in an embodiment of FIG. 7b, PMI(1) is the baseline PMI; PMI(2) may be calculated based on PMI(1) and corresponding offset value Δ₁; PMI(3) may be calculated based on PMI(2) and corresponding offset value Δ₂; PMI(4) may be calculated based on PMI(3) and corresponding offset value Δ₃; and PMI(N) may be calculated based on PMI(N−1) and corresponding offset value Δ_{N-1}.

In some embodiments, some offset values within the set of offset values each may indicate an offset value for a PMI associated with a corresponding PRG with respect to a PMI associated with an adjacent PRG of the PRG, and some other offset values within the set of offset values each may indicate an offset value for a PMI associated with a corresponding PRG with respect to the baseline PMI.

The above embodiments are directed to separately indicating PMIS via independent bit strings and separately indicating PMIS based on the baseline PMI and offset values. In some embodiments, the higher layer signaling or DCI may include a joint indicator to indicate the plurality of PMIS jointly. In these embodiments, PMIS may be indicated effectively due to the joint indicator.

For example, Table 2 below shows a PMI indicator that indicates two PMIS (PMI(1) and PMI(2)) jointly. In the embodiment, each of PMI(1) and PMI(2) may have five values, 0, 1, 2, 3, and 4. Therefore, 25 indicators are needed, for example, 0, 1, 2, 3, . . . , 23, 24.

| PMI indicator for a PRG | PMI(1) | PMI(2) |
|---|---|---|
| 0 | 0 | 0 |
| 1 | 1 | 0 |
| 2 | 2 | 0 |
| 3 | 3 | 0 |
| 4 | 4 | 0 |
| 5 | 0 | 1 |
| 6 | 1 | 1 |
| . . . | . . . | . . . |
| 23 | 3 | 4 |
| 24 | 4 | 4 |

In MIMO transmission, the AN 111 may transmit a Transmit Rank Indicator (TRI) to the UE 101 via higher layer signaling or DCI. The TRI is configured to indicate a rank being scheduled. The codebooks may be different when different ranks are scheduled as matrix dimensions of the precoders within the codebooks are different. Therefore, the UE 101 may determine the precoder for each of the plurality of PRGs based on the TRI and the PMI corresponding to the PRG.

In some embodiments, the AN 111 may code the TRI and at least one of the plurality of PMIS jointly. For example, a mapping table may be preconfigured to show mapping between joint-coding indicator and TRI and PMI, which is similar to Table 2 above.

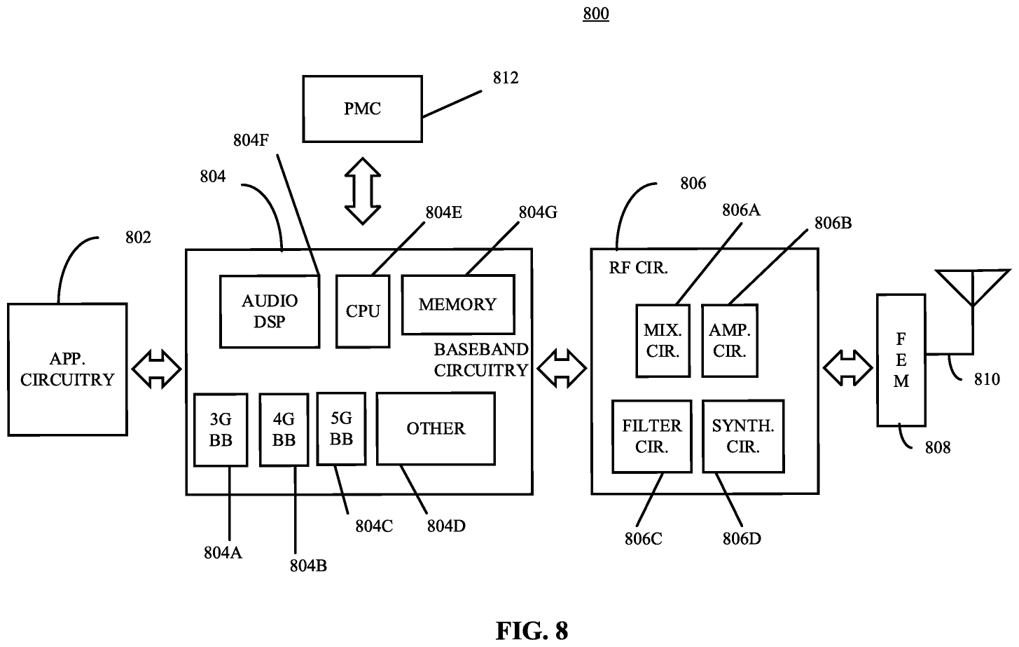

FIG. 8 illustrates example components of a device 800 in accordance with some embodiments. In some embodiments, the device 800 may include application circuitry 802, baseband circuitry 804, Radio Frequency (RF) circuitry 806, front-end module (FEM) circuitry 808, one or more antennas 810, and power management circuitry (PMC) 812 coupled together at least as shown. The components of the illustrated device 800 may be included in a UE or an AN. In some embodiments, the device 800 may include less elements (e.g., an AN may not utilize application circuitry 802, and instead include a processor/controller to process IP data received from an EPC). In some embodiments, the device 800 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 802 may include one or more application processors. For example, the application circuitry 802 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 800. In some embodiments, processors of application circuitry 802 may process IP data packets received from an EPC.

The baseband circuitry 804 may include circuitry such as, but not limited to, one or more single-core or multi-core processors. The baseband circuitry 804 may include one or more baseband processors or control logic to process baseband signals received from a receive signal path of the RF circuitry 806 and to generate baseband signals for a transmit signal path of the RF circuitry 806. Baseband processing circuitry 804 may interface with the application circuitry 802 for generation and processing of the baseband signals and for controlling operations of the RF circuitry 806. For example, in some embodiments, the baseband circuitry 804 may include a third generation (3G) baseband processor 804A, a fourth generation (4G) baseband processor 804B, a fifth generation (5G) baseband processor 804C, or other baseband processor(s) 804D for other existing generations, generations in development or to be developed in the future (e.g., second generation (2G), sixth generation (6G), etc.). The baseband circuitry 804 (e.g., one or more of baseband processors 804A-D) may handle various radio control functions that enable communication with one or more radio networks via the RF circuitry 806. In other embodiments, some or all of the functionality of baseband processors 804A-D may be included in modules stored in the memory 804G and executed via a Central Processing Unit (CPU) 804E. The radio control functions may include, but are not limited to, signal modulation/demodulation, encoding/decoding, radio frequency shifting, etc. In some embodiments, modulation/demodulation circuitry of the baseband circuitry 804 may include Fast-Fourier Transform (FFT), precoding, or constellation mapping/demapping functionality. In some embodiments, encoding/decoding circuitry of the baseband circuitry 804 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 804 may include one or more audio digital signal processor(s) (DSP) 804F. The audio DSP(s) 804F may include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 804 and the application circuitry 802 may be implemented together such as, for example, on a system on a chip (SOC).

In some embodiments, the baseband circuitry 804 may provide for communication compatible with one or more radio technologies. For example, in some embodiments, the baseband circuitry 804 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 804 is configured to support radio communications of more than one wireless protocol may be referred to as multi-mode baseband circuitry.

RF circuitry 806 may enable communication with wireless networks using modulated electromagnetic radiation through a non-solid medium. In various embodiments, the RF circuitry 806 may include switches, filters, amplifiers, etc. to facilitate the communication with the wireless network. RF circuitry 806 may include a receive signal path which may include circuitry to down-convert RF signals received from the FEM circuitry 808 and provide baseband signals to the baseband circuitry 804. RF circuitry 806 may also include a transmit signal path which may include circuitry to up-convert baseband signals provided by the baseband circuitry 804 and provide RF output signals to the FEM circuitry 808 for transmission.

In some embodiments, the receive signal path of the RF circuitry 806 may include mixer circuitry 806a, amplifier circuitry 806b and filter circuitry 806c. In some embodiments, the transmit signal path of the RF circuitry 806 may include filter circuitry 806c and mixer circuitry 806a. RF circuitry 806 may also include synthesizer circuitry 806d for synthesizing a frequency for use by the mixer circuitry 806a of the receive signal path and the transmit signal path. In some embodiments, the mixer circuitry 806a of the receive signal path may be configured to down-convert RF signals received from the FEM circuitry 808 based on the synthesized frequency provided by synthesizer circuitry 806d. The amplifier circuitry 806b may be configured to amplify the down-converted signals and the filter circuitry 806c may be a low-pass filter (LPF) or band-pass filter (BPF) configured to remove unwanted signals from the down-converted signals to generate output baseband signals. Output baseband signals may be provided to the baseband circuitry 804 for further processing. In some embodiments, the output baseband signals may be zero-frequency baseband signals, although this is not a requirement. In some embodiments, mixer circuitry 806a of the receive signal path may comprise passive mixers, although the scope of the embodiments is not limited in this respect.

In some embodiments, the mixer circuitry 806a of the transmit signal path may be configured to up-convert input baseband signals based on the synthesized frequency provided by the synthesizer circuitry 806d to generate RF output signals for the FEM circuitry 808. The baseband signals may be provided by the baseband circuitry 804 and may be filtered by filter circuitry 806c.

In some embodiments, the mixer circuitry 806a of the receive signal path and the mixer circuitry 806a of the transmit signal path may include two or more mixers and may be arranged for quadrature downconversion and upconversion, respectively. In some embodiments, the mixer circuitry 806a of the receive signal path and the mixer circuitry 806a of the transmit signal path may include two or more mixers and may be arranged for image rejection (e.g., Hartley image rejection). In some embodiments, the mixer circuitry 806a of the receive signal path and the mixer circuitry 806a may be arranged for direct downconversion and direct upconversion, respectively. In some embodiments, the mixer circuitry 806a of the receive signal path and the mixer circuitry 806a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 806 may include analog-to-digital converter (ADC) and digital-to-analog converter (DAC) circuitry and the baseband circuitry 804 may include a digital baseband interface to communicate with the RF circuitry 806.

In some dual-mode embodiments, a separate radio IC circuitry may be provided for processing signals for each spectrum, although the scope of the embodiments is not limited in this respect.

In some embodiments, the synthesizer circuitry 806d may be a fractional-N synthesizer or a fractional N/N+1 synthesizer, although the scope of the embodiments is not limited in this respect as other types of frequency synthesizers may be suitable. For example, synthesizer circuitry 806d may be a delta-sigma synthesizer, a frequency multiplier, or a synthesizer comprising a phase-locked loop with a frequency divider.

The synthesizer circuitry 806d may be configured to synthesize an output frequency for use by the mixer circuitry 806a of the RF circuitry 806 based on a frequency input and a divider control input. In some embodiments, the synthesizer circuitry 806d may be a fractional N/N+1 synthesizer.

In some embodiments, frequency input may be provided by a voltage controlled oscillator (VCO), although that is not a requirement. Divider control input may be provided by either the baseband circuitry 804 or the applications processor 802 depending on the desired output frequency. In some embodiments, a divider control input (e.g., N) may be determined from a look-up table based on a channel indicated by the applications processor 802.

Synthesizer circuitry 806d of the RF circuitry 806 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 806d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 806 may include an IQ/polar converter.

FEM circuitry 808 may include a receive signal path which may include circuitry configured to operate on RF signals received from one or more antennas 810, amplify the received signals and provide the amplified versions of the received signals to the RF circuitry 806 for further processing. FEM circuitry 808 may also include a transmit signal path which may include circuitry configured to amplify signals for transmission provided by the RF circuitry 806 for transmission by one or more of the one or more antennas 810. In various embodiments, the amplification through the transmit or receive signal paths may be done solely in the RF circuitry 806, solely in the FEM 808, or in both the RF circuitry 806 and the FEM 808.

In some embodiments, the FEM circuitry 808 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 806). The transmit signal path of the FEM circuitry 808 may include a power amplifier (PA) to amplify input RF signals (e.g., provided by RF circuitry 806), and one or more filters to generate RF signals for subsequent transmission (e.g., by one or more of the one or more antennas 810).

In some embodiments, the PMC 812 may manage power provided to the baseband circuitry 804. In particular, the PMC 812 may control power-source selection, voltage scaling, battery charging, or DC-to-DC conversion. The PMC 812 may often be included when the device 800 is capable of being powered by a battery, for example, when the device is included in a UE. The PMC 812 may increase the power conversion efficiency while providing desirable implementation size and heat dissipation characteristics.

While FIG. 8 shows the PMC 812 coupled only with the baseband circuitry 804. However, in other embodiments, the PMC 812 may be additionally or alternatively coupled with, and perform similar power management operations for, other components such as, but not limited to, application circuitry 802, RF circuitry 806, or FEM 808.

In some embodiments, the PMC 812 may control, or otherwise be part of, various power saving mechanisms of the device 800. For example, if the device 800 is in an RRC Connected state, where it is still connected to the RAN node as it expects to receive traffic shortly, then it may enter a state known as Discontinuous Reception Mode (DRX) after a period of inactivity. During this state, the device 800 may power down for brief intervals of time and thus save power.

If there is no data traffic activity for an extended period of time, then the device 800 may transition off to an RRC Idle state, where it disconnects from the network and does not perform operations such as channel quality feedback, handover, etc. The device 800 goes into a very low power state and it performs paging where again it periodically wakes up to listen to the network and then powers down again. The device 800 may not receive data in this state, in order to receive data, it must transition back to RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 802 and processors of the baseband circuitry 804 may be used to execute elements of one or more instances of a protocol stack. For example, processors of the baseband circuitry 804, alone or in combination, may be used execute Layer 3, Layer 2, or Layer 1 functionality, while processors of the application circuitry 804 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer. As referred to herein, Layer 2 may comprise a medium access control (MAC) layer, a radio link control (RLC) layer, and a packet data convergence protocol (PDCP) layer. As referred to herein, Layer 1 may comprise a physical (PHY) layer of a UE/RAN node.

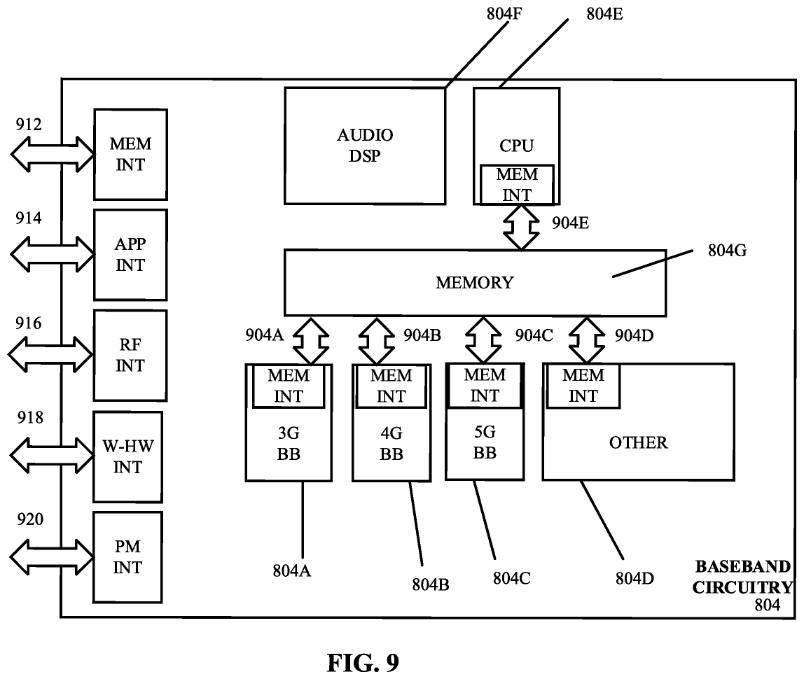

FIG. 9 illustrates example interfaces of baseband circuitry in accordance with some embodiments. As discussed above, the baseband circuitry 804 of FIG. 8 may comprise processors 804A-804E and a memory 804G utilized by said processors. Each of the processors 804A-804E may include a memory interface, 904A-904E, respectively, to send/receive data to/from the memory 804G.

The baseband circuitry 804 may further include one or more interfaces to communicatively couple to other circuitries/devices, such as a memory interface 912 (e.g., an interface to send/receive data to/from memory external to the baseband circuitry 804), an application circuitry interface 914 (e.g., an interface to send/receive data to/from the application circuitry 802 of FIG. 8), an RF circuitry interface 916 (e.g., an interface to send/receive data to/from RF circuitry 806 of FIG. 8), a wireless hardware connectivity interface 918 (e.g., an interface to send/receive data to/from Near Field Communication (NFC) components, Bluetooth® components (e.g., Bluetooth® Low Energy), Wi-Fi® components, and other communication components), and a power management interface 920 (e.g., an interface to send/receive power or control signals to/from the PMC 812.

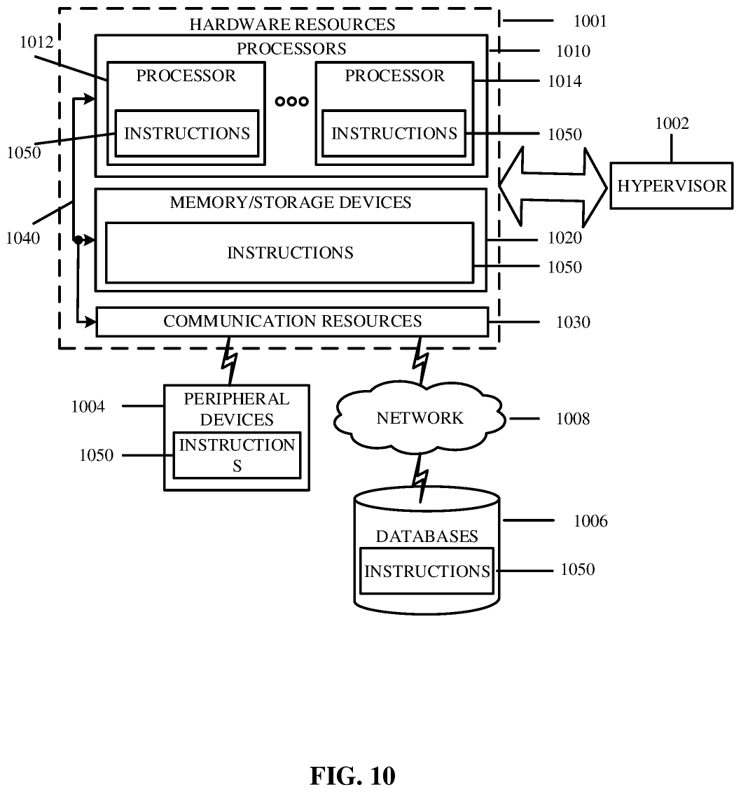

FIG. 10 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors (or processor cores) 1010, one or more memory/storage devices 1020, and one or more communication resources 1030, each of which may be communicatively coupled via a bus 1040. For embodiments where node virtualization (e.g., NFV) is utilized, a hypervisor 1002 may be executed to provide an execution environment for one or more network slices/sub-slices to utilize the hardware resources 1000.

The processors 1010 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1012 and a processor 1014.

The memory/storage devices 1020 may include main memory, disk storage, or any suitable combination thereof. The memory/storage devices 1020 may include, but are not limited to any type of volatile or non-volatile memory such as dynamic random access memory (DRAM), static random-access memory (SRAM), erasable programmable read-only memory (EPROM), electrically erasable programmable read-only memory (EEPROM), Flash memory, solid-state storage, etc.

The communication resources 1030 may include interconnection or network interface components or other suitable devices to communicate with one or more peripheral devices 1004 or one or more databases 1006 via a network 1008. For example, the communication resources 1030 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1050 may comprise software, a program, an application, an applet, an app, or other executable code for causing at least any of the processors 1010 to perform any one or more of the methodologies discussed herein. The instructions 1050 may reside, completely or partially, within at least one of the processors 1010 (e.g., within the processor's cache memory), the memory/storage devices 1020, or any suitable combination thereof. Furthermore, any portion of the instructions 1050 may be transferred to the hardware resources 1000 from any combination of the peripheral devices 1004 or the databases 1006. Accordingly, the memory of processors 1010, the memory/storage devices 1020, the peripheral devices 1004, and the databases 1006 are examples of computer-readable and machine-readable media.

The following paragraphs describe examples of various embodiments.

Example 1 includes an apparatus for a user equipment (UE), comprising: circuitry configured to: determine a precoder for each of a plurality of precoder resource block groups (PRGs) for an uplink transmission, wherein the plurality of PRGs are configurable in at least one of PRG size and number; and precode each of the plurality of PRGs with a determined precoder; and a memory to store the determined precoder for each of the plurality of PRGs.

Example 2 includes the apparatus of Example 1, wherein the circuitry is configured to: decode higher layer signaling or downlink control information (DCI) transmitted from an access node to obtain one or more precoder matrix indicators (PMIs); and wherein the precoder for each of the plurality of PRGs is determined based on the one or more PMIS.

Example 3 includes the apparatus of Example 2, wherein the higher layer signaling or DCI is dedicated to indicate the one or more PMIS.

Example 4 includes the apparatus of Example 2, wherein the higher layer signaling or DCI is associated with uplink grant for the uplink transmission.

Example 5 includes the apparatus of Example 2, wherein the one or more PMIS comprise a single PMI, and the circuitry is configured to determine the precoder for each of the plurality of PRGs by: obtaining a first precoder for the plurality of PRGs based on the PMI and a first codebook; selecting, for each of the plurality of PRGs, a second precoder from a second codebook; and determining the precoder for each of the plurality of PRGs based on both of the second precoder for each of the plurality of PRGs and the first precoder.

Example 6 includes the apparatus of Example 5, wherein the circuitry is configured to: obtain a first codebook subset restriction indicating a subset of the first codebook, wherein the first precoder for the plurality of PRGs is obtained based on the PMI and the subset of the first codebook.

Example 7 includes the apparatus of Example 5 or 6, wherein the circuitry is configured to: obtain a second codebook subset restriction indicating a subset of the second codebook, wherein the second precoder for each of the plurality of PRGs is selected from the subset of the second codebook.

Example 8 includes the apparatus of Example 2, wherein the one or more PMIS comprise a plurality of PMIS, and wherein the precoder for each of the plurality of PRGs is determined by associating one of the plurality of PMIS with the PRG.

Example 9 includes the apparatus of Example 8, wherein the number of the plurality of PMIS is equal to the number of the plurality of PRGs.

Example 10 includes the apparatus of Example 9, wherein the plurality of PRGs comprise one or more unscheduled PRGs, and wherein each of the one or more unscheduled PRGs is associated with a PMI that has a predefined value.

Example 11 includes the apparatus of Example 1, wherein the circuitry is configured to: determine whether assistance from an access node is required in determining the precoder for each of the plurality of PRGs based on one of: predefinition, higher layer signaling or DCI from the access node, and the number of transmission antenna ports of the UE.

Example 12 includes the apparatus of Example 1, wherein the plurality of PRGs comprise one or more different physical resource blocks (PRBs) in frequency domain that occupy the same time resource.

Example 13 includes the apparatus of Example 1, wherein the plurality of PRGs comprise one or more different time units in time domain that occupy the same frequency resource.

Example 14 includes the apparatus of Example 1, wherein the number of the plurality of PRGs is determined based on at least one of predefinition, higher layer signaling or DCI, bandwidth associated with the plurality of PRGs, and DMRS information.

Example 15 includes the apparatus of Example 1, wherein the PRG size for each of the plurality of PRGs is determined based on at least one of predefinition, higher layer signaling or DCI, bandwidth associated with the plurality of PRGs, and DMRS information.

Example 16 includes the apparatus of Example 1, wherein each of the plurality of PRGs comprise one or more scheduled PRBs but no unscheduled PRBs.

Example 17 includes the apparatus of Example 1, wherein at least one of the plurality of PRGs comprise both of one or more scheduled PRBs and one or more unscheduled PRBs.

Example 18 includes a method performed at a user equipment (UE), comprising: determining a precoder for each of a plurality of precoder resource block groups (PRGs) for an uplink transmission, wherein the plurality of PRGs are configurable in at least one of PRG size and number; and precoding each of the plurality of PRGs with a determined precoder.

Example 19 includes the method of Example 18, further comprising: decoding higher layer signaling or downlink control information (DCI) transmitted from an access node to obtain one or more precoder matrix indicators (PMIs); and wherein the precoder for each of the plurality of PRGs is determined based on the one or more PMIS.

Example 20 includes the method of Example 19, wherein the higher layer signaling or DCI is dedicated to indicate the one or more PMIS.

Example 21 includes the method of Example 19, wherein the higher layer signaling or DCI is associated with uplink grant for the uplink transmission.

Example 22 includes the method of Example 19, wherein the one or more PMIS comprise a single PMI, and determining the precoder for each of the plurality of PRGs comprises: obtaining a first precoder for the plurality of PRGs based on the PMI and a first codebook; selecting, for each of the plurality of PRGs, a second precoder from a second codebook; and determining the precoder for each of the plurality of PRGs based on both of the second precoder for each of the plurality of PRGs and the first precoder.

Example 23 includes the method of Example 22, further comprising: obtaining a first codebook subset restriction indicating a subset of the first codebook, wherein the first precoder for the plurality of PRGs is obtained based on the PMI and the subset of the first codebook.

Example 24 includes the method of Example 22 or 23, further comprising: obtaining a second codebook subset restriction indicating a subset of the second codebook, wherein the second precoder for each of the plurality of PRGs is selected from the subset of the second codebook.

Example 25 includes the method of Example 19, wherein the one or more PMIS comprise a plurality of PMIS, and wherein the precoder for each of the plurality of PRGs is determined by associating one of the plurality of PMIS with the PRG.

Example 26 includes the method of Example 25, wherein the number of the plurality of PMIS is equal to the number of the plurality of PRGs.

Example 27 includes the method of Example 26, wherein the plurality of PRGs comprise one or more unscheduled PRGs, and wherein each of the one or more unscheduled PRGs is associated with a PMI that has a predefined value.

Example 28 includes the method of Example 18, further comprising: determining whether assistance from an access node is required in determining the precoder for each of the plurality of PRGs based on one of: predefinition, higher layer signaling or DCI from the access node, and the number of transmission antenna ports of the UE.

Example 29 includes the method of Example 18, wherein the plurality of PRGs comprise one or more different physical resource blocks (PRBs) in frequency domain that occupy the same time resource.

Example 30 includes the method of Example 18, wherein the plurality of PRGs comprise one or more different time units in time domain that occupy the same frequency resource.

Example 31 includes the method of Example 18, wherein the number of the plurality of PRGs is determined based on at least one of predefinition, higher layer signaling or DCI, bandwidth associated with the plurality of PRGs, and DMRS information.

Example 32 includes the method of Example 18, wherein the PRG size for each of the plurality of PRGs is determined based on at least one of predefinition, higher layer signaling or DCI, bandwidth associated with the plurality of PRGs, and DMRS information.

Example 33 includes the method of Example 18, wherein each of the plurality of PRGs comprise one or more scheduled PRBs but no unscheduled PRBs.

Example 34 includes the method of Example 18, wherein at least one of the plurality of PRGs comprise both of one or more scheduled PRBs and one or more unscheduled PRBs.

Example 35 includes an apparatus for a user equipment (UE), comprising: circuitry configured to: determine a plurality of precoder matrix indicators (PMIS) for a plurality of precoder resource block groups (PRGs) for an uplink transmission based on higher layer signaling or downlink control information (DCI) transmitted from an access node, wherein the plurality of PRGs are configurable in at least one of PRG size and number; and a memory to store the determined plurality of PMIS.

Example 36 includes the apparatus of Example 35, wherein the higher layer signaling or DCI comprises a plurality of bit strings each of which indicates one of the plurality of PMIS.

Example 37 includes the apparatus of Example 35, wherein the higher layer signaling or DCI comprises a set of offset values corresponding to one or more of the plurality of PRGs and a baseline PMI, and wherein the plurality of PMIS are determined based on the baseline PMI and the set of offset values.

Example 38 includes the apparatus of Example 37, wherein the baseline PMI is configured to indicate a PMI corresponding to a frequency band associated with the uplink transmission.

Example 39 includes the apparatus of Example 37, wherein the baseline PMI is configured to indicate a PMI for a particular PRG of the plurality of PRGs.

Example 40 includes the apparatus of Example 37, wherein at least one offset value within the set of offset values is configured to indicate an offset value for a PMI associated with a corresponding PRG of the plurality of PRGs with respect to the baseline PMI.

Example 41 includes the apparatus of Example 37, wherein at least one offset value within the set of offset values is configured to indicate an offset value for a PMI associated with a corresponding PRG of the plurality of PRGs with respect to a PMI associated with an adjacent PRG of the PRG.

Example 42 includes the apparatus of Example 35, wherein the higher layer signaling or DCI comprises a joint indicator to indicate the plurality of PMIS jointly.

Example 43 includes the apparatus of Example 35, wherein the circuitry is configured to: decode higher layer signaling or DCI to obtain a transmit rank indicator (TRI) which is configured to indicate a rank being scheduled; and determine a precoder for each of the plurality of PRGs based on the TRI and a PMI corresponding to the PRG.

Example 44 includes the apparatus of Example 43, wherein the TRI and at least one of the plurality of PMIS are coded jointly.

Example 45 includes a method performed at a user equipment (UE), comprising: determining a plurality of precoder matrix indicators (PMIS) for a plurality of precoder resource block groups (PRGs) for an uplink transmission based on higher layer signaling or downlink control information (DCI) transmitted from an access node, wherein the plurality of PRGs are configurable in at least one of PRG size and number.

Example 46 includes the method of Example 45, wherein the higher layer signaling or DCI comprises a plurality of bit strings each of which indicates one of the plurality of PMIS.

Example 47 includes the method of Example 45, wherein the higher layer signaling or DCI comprises a set of offset values corresponding to one or more of the plurality of PRGs and a baseline PMI, and wherein the plurality of PMIS are determined based on the baseline PMI and the set of offset values.

Example 48 includes the method of Example 47, wherein the baseline PMI is configured to indicate a PMI corresponding to a frequency band associated with the uplink transmission.

Example 49 includes the method of Example 47, wherein the baseline PMI is configured to indicate a PMI for a particular PRG of the plurality of PRGs.

Example 50 includes the method of Example 47, wherein at least one offset value within the set of offset values is configured to indicate an offset value for a PMI associated with a corresponding PRG of the plurality of PRGs with respect to the baseline PMI.

Example 51 includes the method of Example 47, wherein at least one offset value within the set of offset values is configured to indicate an offset value for a PMI associated with a corresponding PRG of the plurality of PRGs with respect to a PMI associated with an adjacent PRG of the PRG.

Example 52 includes the method of Example 45, wherein the higher layer signaling or DCI comprises a joint indicator to indicate the plurality of PMIS jointly.

Example 53 includes the method of Example 45, further comprising: decoding higher layer signaling or DCI to obtain a transmit rank indicator (TRI) which is configured to indicate a rank being scheduled; and determining a precoder for each of the plurality of PRGs based on the TRI and a PMI corresponding to the PRG.

Example 54 includes the method of Example 53, wherein the TRI and at least one of the plurality of PMIS are coded jointly.

Example 55 includes a non-transitory computer-readable medium having instructions stored thereon, the instructions when executed by one or more processor(s) causing the processor(s) to perform the method of any of Examples 18-34.

Example 56 includes a non-transitory computer-readable medium having instructions stored thereon, the instructions when executed by one or more processor(s) causing the processor(s) to perform the method of any of Examples 45-54.

Example 57 includes an apparatus for user equipment (UE), including means for performing the actions of the method of any of Examples 18-34.

Example 58 includes an apparatus for user equipment (UE), including means for performing the actions of the method of any of Examples 45-54.

Example 59 includes user equipment (UE) as shown and described in the description.

Example 60 includes a method performed at user equipment (UE) as shown and described in the description.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the appended claims and the equivalents thereof.

1. An apparatus for a user equipment (UE), the apparatus comprising:
one or more processors configured to:
determine a precoder for each of a plurality of precoder resource block groups (PRGs) for an uplink transmission, wherein the plurality of PRGs are configurable in at least one of PRG size and number; and
precode each of the plurality of PRGs with a determined precoder; and
a memory to store the determined precoder for each of the plurality of PRGs.

2. The apparatus of claim 1, wherein the one or more processors are further configured to:
decode higher layer signaling or downlink control information (DCI) transmitted from an access node to obtain one or more precoder matrix indicators (PMIs), wherein the precoder for each of the plurality of PRGs is determined based on the one or more PMIs.

3. The apparatus of claim 2, wherein the higher layer signaling or DCI is dedicated to indicate the one or more PMIs.

4. The apparatus of claim 2, wherein the higher layer signaling or DCI is associated with uplink grant for the uplink transmission.

5. The apparatus of claim 2, wherein the one or more PMIs comprise a single PMI, and wherein determining the precoder for each of the plurality of PRGs comprises:
obtaining a first precoder for the plurality of PRGs based on the PMI and a first codebook;
selecting, for each of the plurality of PRGs, a second precoder from a second codebook; and
determining the precoder for each of the plurality of PRGs based on both of the second precoder for each of the plurality of PRGs and the first precoder.

6. The apparatus of claim 5, wherein the one or more processors are further configured to:
obtain a first codebook subset restriction indicating a subset of the first codebook, wherein the first precoder for the plurality of PRGs is obtained based on the PMI and the subset of the first codebook.

7. The apparatus of claim 5, wherein the one or more processors are further configured to:
obtain a second codebook subset restriction indicating a subset of the second codebook,
wherein the second precoder for each of the plurality of PRGs is selected from the subset of the second codebook.

8. The apparatus of claim 2, wherein the one or more PMIs comprise a plurality of PMIs, and wherein the precoder for each of the plurality of PRGs is determined by associating one of the plurality of PMIs with the PRG.

9. The apparatus of claim 8, wherein the number of the plurality of PMIs is equal to the number of the plurality of PRGs.

10. The apparatus of claim 9, wherein the plurality of PRGs comprise one or more unscheduled PRGs, and wherein each of the one or more unscheduled PRGs is associated with a PMI that has a predefined value.

11. The apparatus of claim 1, wherein the one or more processors are further configured to:
determine whether assistance from an access node is required in determining the precoder for each of the plurality of PRGs based on one of: predefinition, higher layer signaling or DCI from the access node, and the number of transmission antenna ports of the UE.

12. The apparatus of claim 1, wherein the plurality of PRGs comprise one or more different physical resource blocks (PRBs) in frequency domain that occupy the same time resource.

13. The apparatus of claim 1, wherein the plurality of PRGs comprise one or more different time units in time domain that occupy the same frequency resource.

14. The apparatus of claim 1, wherein the number of the plurality of PRGs is determined based on at least one of predefinition, higher layer signaling or DCI, bandwidth associated with the plurality of PRGs, or DMRS information.

15. The apparatus of claim 1, wherein the PRG size for each of the plurality of PRGs is determined based on at least one of predefinition, higher layer signaling or DCI, bandwidth associated with the plurality of PRGs, or DMRS information.

16. The apparatus of claim 1, wherein each of the plurality of PRGs comprise one or more scheduled PRBs but no unscheduled PRBs.

17. The apparatus of claim 1, wherein at least one of the plurality of PRGs comprise both of one or more scheduled PRBs and one or more unscheduled PRBs.

18. An apparatus for a user equipment (UE), comprising:
one or more processors configured to:
determine a plurality of precoder matrix indicators (PMIs) for a plurality of precoder resource block groups (PRGs) for an uplink transmission based on higher layer signaling or downlink control information (DCI) transmitted from an access node, wherein the plurality of PRGs are configurable in at least one of PRG size and number; and
a memory to store the determined plurality of PMIs.

19. The apparatus of claim 18, wherein the higher layer signaling or DCI comprises a plurality of bit strings each of which indicates one of the plurality of PMIs.

20. The apparatus of claim 18, wherein the higher layer signaling or DCI comprises a set of offset values corresponding to one or more of the plurality of PRGs and a baseline PMI, and wherein the plurality of PMIs are determined based on the baseline PMI and the set of offset values.

21. The apparatus of claim 20, wherein the baseline PMI is configured to indicate a PMI corresponding to a frequency band associated with the uplink transmission.

22. The apparatus of claim 20, wherein the baseline PMI is configured to indicate a PMI for a particular PRG of the plurality of PRGs.

23. The apparatus of claim 20, wherein at least one offset value within the set of offset values is configured to indicate an offset value for a PMI associated with a corresponding PRG of the plurality of PRGs with respect to the baseline PMI.

24. (canceled)

25. (canceled)
